(19) United States
(12) Patent Application Publication
(10) Pub. No.: US 2025/0303499 A1
(43) Pub. Date: Oct. 2, 2025

(54) LIGHT SOURCE DEVICE AND HEATING SYSTEM INCLUDING LIGHT SOURCE DEVICE

(71) Applicant: NICHIA CORPORATION, Anan-shi (JP)

(72) Inventor: Keiichi MOCHIZUKI, Matsumoto-shi (JP)

(73) Assignee: NICHIA CORPORATION, Anan-shi (JP)

(21) Appl. No.: 19/082,170

(22) Filed: Mar. 18, 2025

(30) Foreign Application Priority Data
Mar. 26, 2024 (JP) 2024-049782

(51) Int. Cl. B23K 26/352; B23K 26/06; B23K 26/08; H01M 4/04

(52) U.S. Cl. CPC B23K 26/352; B23K 26/0643; B23K 26/0648; B23K 26/0838; H01M 4/0471

(57) ABSTRACT

The light source device includes first and second laser light sources disposed at distances, in a first direction, from a first surface to be irradiated. The light source device further includes a first reflective surface that is disposed at a position away from the first laser light source in a second direction along the first surface and that reflects first light from the first laser light source toward a first portion of the first surface, a second reflective surface that is disposed at a position away from the second laser light source in the second direction and that reflects second light from the second laser light source toward a second portion away from the first portion of the first surface in an opposite direction, and a first diffusion plate on which the first light and the second light are incident.

### CROSS-REFERENCE TO RELATED APPLICATION

This application claims priority to Japanese Patent Application No. 2024-049782, filed on Mar. 26, 2024, the disclosure of which is hereby incorporated by reference in its entirety.

### TECHNICAL FIELD

The present disclosure relates to a light source device and a heating system including the light source device.

### BACKGROUND

Japanese Patent Publication No. 2017-134992 describes a lighting device in which a projection surface is uniformly irradiated with light and a density of irradiation to an irradiation optical system is reduced by a transmission diffusion plate. The lighting device includes a light-emitting portion that emits light, a condensation portion that condenses the light emitted from the light-emitting portion, a first diffusion portion that diffuses the light condensed by the condensation portion, a homogenizing optical system that emits light after homogenizing an illuminance distribution, and a second diffusion portion that diffuses the light emitted from the homogenizing optical system.

### SUMMARY

Semiconductor lasers have been used not only for lighting but also for various processes such as heating, drying, and processing. In a system using a semiconductor laser for lighting, processing, or the like, a light source device that can more uniformly emit a laser beam is needed.

One aspect of the present disclosure is a light source device including a first laser light source disposed at a first distance, in a first direction, from a first surface to be irradiated; a second laser light source disposed at a second distance from the first surface in the first direction, the second distance being shorter than the first distance; a first reflective surface disposed at a first position away from the first laser light source in a second direction along the first surface; and a second reflective surface disposed at a second position further away from the second laser light source in the second direction than the first position is away from the first laser light source in the second direction. The first reflective surface reflects first light from the first laser light source toward a first portion of the first surface, the second reflective surface reflects second light from the second laser light source toward a second portion that is away from the first portion of the first surface in the second direction and in an opposite direction to the second position relative to the first position, and the light source device further includes a first diffusion plate on which the first light and the second light are incident.

One of other aspects of the present disclosure is a light source device including a heat dissipation substrate having a first support surface; a first laser light source and a second laser light source disposed along a first virtual axis extending in a first direction parallel to the first support surface; a first reflective surface configured to reflect first light from the first laser light source at a first position in the first direction such that the first light forms a first angle with respect to the first virtual axis, the first position being away from the first virtual axis in a second direction orthogonal to the first support surface; a second reflective surface configured to reflect second light from the second laser light source at a second position in the first direction such that the second light forms a second angle larger than the first angle with respect to the first virtual axis, the second position being further away from the first virtual axis in the second direction than the first position is away from the first virtual axis in the second direction, and to cause an optical axis of the first light and an optical axis of the second light to intersect with each other; and a first diffusion plate common to the first light and the second light.

An aspect of the present disclosure can provide a light source device that can more uniformly emit a laser beam.

### BRIEF DESCRIPTION OF DRAWINGS

FIG. 1 is a diagram illustrating an outline of a heating system.

FIG. 2 is a diagram illustrating an outline of a light source device.

FIG. 3 is a diagram illustrating an example of a laser diode (LD) chip package.

FIG. 4 is a diagram illustrating an outline of another example of a light source device.

FIG. 5 is a diagram illustrating an outline of another example of a light source device.

FIG. 6 is a diagram illustrating a state of a heat dissipation substrate viewed from above.

FIG. 7 is a diagram illustrating a state of a light source device viewed from the back.

FIG. 8 is a diagram illustrating an outline of another example of a light source device.

FIG. 9A is an image showing an example of an illuminance distribution on an irradiation surface.

FIG. 9B is an image showing another example of illuminance distribution on an irradiation surface.

FIG. 9C is an image showing another example of illuminance distribution on an irradiation surface.

### DETAILED DESCRIPTIONS

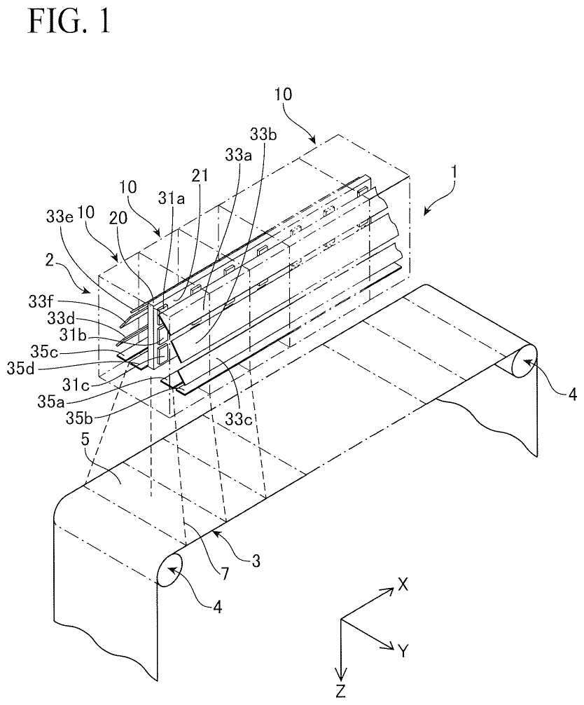

FIG. 1 illustrates an outline of a heating system that heats a target, for example, an electrode material of a secondary battery, as an example of a process apparatus that emits a plurality of laser beams. The heating system 1 includes a conveyance device 4 that conveys a heating target 3 in an X direction, and a heating device 2 that irradiates a surface of the heating target 3 (that is, a region to be irradiated or a first surface 5 to be irradiated) with a laser beam 7 for heating. The heating device 2 includes a plurality of light source devices 10. Each light source device 10 is short length in the X direction being a conveyance direction and large length in a Y direction orthogonal to the X direction, and a plurality of laser light sources 31a to 31c are arranged along a virtual axis 8 extending in a Z direction (that is, a first direction) orthogonal to the first surface 5 of the heating target, so as to be long.

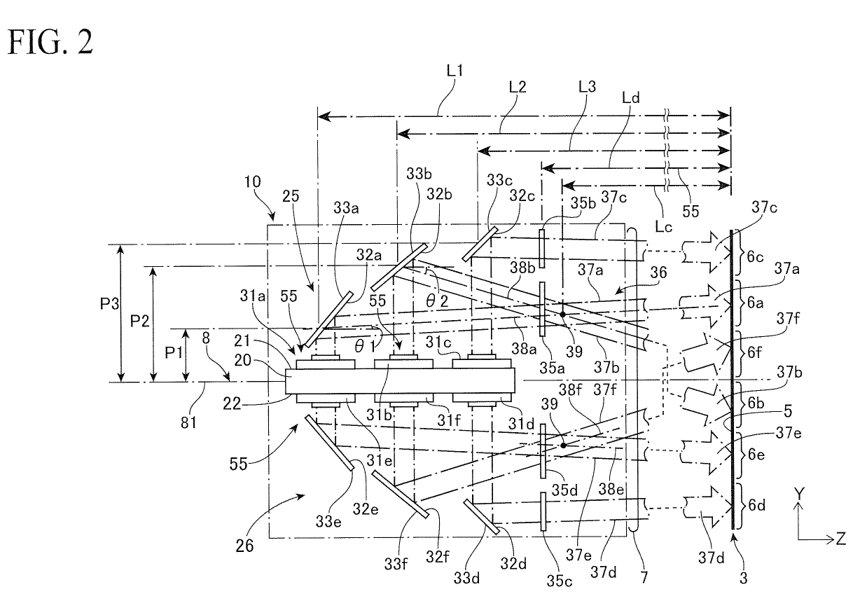

FIG. 2 illustrates a configuration of each light source device 10 viewed from the side (X direction). Each light source device 10 includes a heat dissipation substrate 20 extending along the virtual axis 8 in the Z direction, a first laser light source 31a, a second laser light source 31b, and a third laser light source 31c disposed on one support surface (that is, a first support surface) 21 of the heat dissipation substrate 20 along the virtual axis 8 in the Z direction, and a fourth laser light source 31d, a fifth laser light source 31e, and a sixth laser light source 31f disposed on an opposite support surface (that is, a second support surface) 22 along the virtual axis 8 in the Z direction. The light source device 10 further includes, in the Y direction (that is, a second direction), a first reflecting plate 33a, a second reflecting plate 33b, and a third reflecting plate 33c facing the first support surface 21, and a fourth reflecting plate 33d, a fifth reflecting plate 33e, and a sixth reflecting plate 33f facing the second support surface 22.

In the light source device 10, a first laser beam (that is, first light) 37a output from the first laser light source 31a in the Y direction toward the first reflective surface 32a of the first reflecting plate 33a facing the first support surface 21 is reflected by the first reflective surface 32a in the Z direction and output toward the first surface 5 to be irradiated. A second laser beam (that is, second light) 37b output from the second laser light source 31b in the Y direction toward the second reflective surface 32b of the second reflecting plate 33b facing the first support surface 21 is reflected by the second reflective surface 32b in the Z direction and output toward the first surface 5 to be irradiated. A fifth laser beam (that is, fifth light) 37e output in the Y direction from the fifth laser light source 31e disposed on the second support surface 22 on the opposite side of the heat dissipation substrate 20 toward the fifth reflective surface 32e of the fifth reflecting plate 33e facing the second support surface 22 is reflected by the fifth reflective surface 32e in the Z direction and output toward the first surface 5 to be irradiated. Light from other laser light sources is described in more detail below.

The heat dissipation substrate 20 supporting these laser light sources 31a to 31f can be provided independently for each of the light source devices 10, or can be provided in common for the plurality of light source devices 10 as illustrated in FIG. 1. The heat dissipation substrate 20 can also extend in the X direction being the conveyance direction of the heating system 1. Similarly, the reflecting plates 33a to 33f can be provided independently for each of the light source devices 10, or can be provided in common for the plurality of light source devices 10 as illustrated in FIG. 1, and these reflecting plates 33a to 33f can extend in the X direction.

FIG. 2 illustrates, as an example, the light source device 10 in which these laser light sources 31a to 31f output respective light beams 37a to 37f in the Y direction being a direction orthogonal to the heat dissipation substrate 20, and angles of the respective light beams 37a to 37f toward the first surface 5 to be irradiated can be controlled by the respective reflective surfaces 32a to 32f. Therefore, the emission directions of the laser light sources 31a to 31f do not have be a direction orthogonal to each of the support surfaces 21 and 22 of the heat dissipation substrate 20, and each of the support surfaces 21 and 22 does not have be a flat surface. However, a configuration in which the support surfaces 21 and 22 on both surfaces of the heat dissipation substrate 20 are XZ surfaces, the laser light sources 31a to 31f are disposed on the support surfaces 21 and 22, and the light beams 37a to 37f are output in the Y direction is an example of a simple and preferable configuration in which a heat dissipation effect is easily obtained.

A more specific configuration of an example of the light source device 10 is described. The light source device 10 includes the first laser light source 31a disposed at a first distance L1 away from the first surface 5 to be irradiated in the first direction (that is, the Z direction) and the second laser light source 31b disposed at a second distance L2 from the first surface 5 in the Z direction. The second distance L2 is shorter than the first distance L1. The first distance L1 is the shortest distance from a position where the center of the first light beam 37a hits the first reflective surface 32a to the first surface 5. The distance L2 is the shortest distance to the first surface 5 from a position where the center of the second light beam 37b hits the first reflective surface 32a. A distance L3 is the shortest distance to the first surface 5 from a position where the center of the third light beam 37c hits the third reflective surface 32c. In addition, the light source device 10 includes the first reflective surface 32a and the second reflective surface 32b. The first reflective surface 32a is disposed at a first position P1 away from the first laser light source 31a in the second direction (that is, the Y direction) along the first surface 5, and reflects the first light beam 37a from the first laser light source 31a toward a first portion 6a of the first surface 5. The second reflective surface 32b is disposed at a second position P2 further away from the second laser light source 31b than the first position P1 in the Y direction, and reflects the second light beam 37b from the second laser light source 31b toward a second portion 6b that is away from the first portion 6a of the first surface 5 in the Y direction and in a −Y direction being an opposite direction to the second position P2 in a +Y direction with respect to the first position P1. The first position P1 is determined based on the position of the center of the laser beam emitted to the first reflective surface 32a. The second position P2 is determined based on the position of the center of the laser beam emitted to the second reflective surface 32b. The light source device 10 further includes a first diffusion plate 35a on which the first light beam 37a and the second light beam 37b are incident.

In the light source device 10, the first light beam 37a from the first laser light source 31a is reflected by the first reflective surface 32a and the second light beam 37b from the second laser light source 31b is reflected by the second reflective surface 32b, thereby being directed to the first surface 5. The first laser light source 31a and the second laser light source 31b are disposed at different distances from the first surface 5 to be irradiated in the Z direction. Therefore, instead of disposing the first laser light source 31a and the second laser light source 31b such that the emission directions thereof face the first surface 5, the first laser light source 31a and the second laser light source 31b can be disposed such that the emission directions thereof face the first reflective surface 32a and the second reflective surface 32b disposed in the Y direction, respectively. Accordingly, the plurality of laser light sources 31a and 31b can be away from each other along the first direction perpendicular to the first surface 5 without being widened distance therebetween in the Y direction along the first surface 5 to be irradiated, and the light beam 37a from the laser light source 31a and the light beam 37b from the laser light source 31b can be bundled as a portion of the laser beam 7 to irradiate the first surface 5.

The energy density of the laser beam on the first surface 5 can be, for example, in a range from 1×10⁰ W/cm² (that is, 1 W/cm²) to 1×10² W/cm², preferably in a range from 1×10⁰ W/cm² to 1× 10¹ W/cm². This can efficiently heat or dry a target.

Moreover, the positional relationship between the first reflective surface 32a and the second reflective surface 32b in the second direction along the first surface 5 to be irradiated is determined as the first positional relationship. The positional relationship between the first portion 6a of the first surface 5 to which the first light beam 37a is directed and the second portion 6b of the first surface 5 to which the second light beam 37b is directed is determined as the second positional relationship. The second positional relationship is the reverse of the first positional relationship, and thus an intersection portion 39 between the first light beam 37a and the second light beam 37b occurs at a position Lc from the first surface 5. Therefore, the cross-sectional area (or width) of a light beam bundle 36 including the first light beam 37a and the second light beam 37b is narrowed and then widened. Accordingly, the first diffusion plate 35a on which the first light beam 37a and the second light beam 37b are incident is disposed at a location where the width of the light beam bundle 36 is narrowed, so that the width of the first diffusion plate 35a can be reduced in accordance with an area (or width) of the light beam bundle 36 passing through the first diffusion plate 35a. At the same time, the light beam bundle 36 including the first light beam 37a and the second light beam 37b with reduced directivity can exit from the first diffusion plate 35a toward the first surface 5 as a whole or portion of the laser beam 7 with which the first surface 5 is irradiated. This can provide a light source device 10 that can irradiate the first surface 5 with the laser beam 7 having high energy density and high uniformity. Moreover, in the light source device 10, the plurality of laser light sources 31a and 31b can be disposed in a direction perpendicular to the first surface 5 instead of being disposed along the first surface 5, whereby a light source device 10 can be provided that is long in the Z direction and compact in the X direction and the Y direction facing the first surface 5, especially in the Y direction.

In the present specification, a laser beam having high uniformity refers to a laser beam having a uniformity ratio of 75% or more on the first surface 5. The uniformity ratio can preferably be 80% or more, 85% or more, or 90% or more. Thus, the first surface 5 can be more uniformly irradiated with the laser beam. The uniformity ratio is obtained by measuring an illuminance distribution by using an illuminance meter and calculating a minimum value/a maximum value of the obtained illuminance distribution ×100%.

The light source device 10 includes the heat dissipation substrate 20 having the first support surface 21, the first laser light source 31a and the second laser light source 31b disposed along the first virtual axis 8 extending in the first direction parallel to the first support surface 21, the first reflective surface 32a disposed at the first position P1 away from the first virtual axis 8 in the second direction perpendicular to the first support surface 21, and the second reflective surface 32b disposed at the second position P2 further away from the first virtual axis 8 than the first position P1 in the second direction. The first reflective surface 32a reflects the first light beam 37a from the first laser light source 31a in the first direction so as to form a first angle θ1 with respect to the first virtual axis 8. The second reflective surface 32b reflects the second light beam 37b from the second laser light source 31b in the first direction so as to form a second angle θ2 larger than the first angle θ1 with respect to the first virtual axis 8. In the example of the light source device 10 illustrated in FIG. 2, assuming that the clockwise direction is positive, the first angle θ1 is negative, the second angle θ2 is positive, and the second angle θ2 is larger than the first angle θ1. Accordingly, for the first light beam 37a and the second light beam 37b respectively reflected by the first and second reflective surfaces 32a and 32b, an optical axis 38a of the first light beam 37a and an optical axis 38b of the second light beam 37b intersect with each other at the intersection portion 39 that is at a distance Lc from the first surface 5. The light source device 10 further includes the first diffusion plate 35a common to the first light beam 37a and the second light beam 37b.

In the light source device 10, the first laser light source 31a and the second laser light source 31b are disposed in the Z direction along the first virtual axis 8. The first light beam 37a and the second light beam 37b output from the first laser light source 31a and the second laser light source 31b in the Y direction perpendicular to the first virtual axis 8 can respectively be reflected by the first reflective surface 32a and the second reflective surface 32b and output in substantially the Z direction. Accordingly, a long or wide space for disposing the plurality of laser light sources 31a and 31b can be secured along the first virtual axis 8 along which the first light beam 37a and the second light beam 37b are output, and a large number of laser light sources 31a and 31b can be disposed while the spread in the emission direction (that is, a direction orthogonal to the virtual axis 8) of the light source device 10 is suppressed. In addition, the light beam bundle of the laser beam 7 including the first light beam 37a and the second light beam 37b can be collected in a narrow range orthogonal to the first virtual axis 8. This can provide the light source device 10 that is compact and can output the laser beam 7 having a high energy density.

Moreover, because the optical axis 38a of the first light beam 37a and the optical axis 38b of the second light beam 37b intersect with each other, the light beam bundle 36 including these light beams 37a and 37b is supplied along the first virtual axis 8 in a state in which the cross-sectional area (or width) thereof is spread after being narrowed. Accordingly, the width of the first diffusion plate 35a on which the first light beam 37a and the second light beam 37b are incident can be reduced in accordance with the area (or width) of the light beam bundle 36 passing through the first diffusion plate. In addition, the laser beam 7 including the first light beam 37a and the second light beam 37b with reduced directivity can be output from the first diffusion plate 35a along the first virtual axis 8. This can provide the light source device 10 that can output the laser beam 7 having high energy density and high uniformity along the first virtual axis 8.

The first diffusion plate 35a can be away from the first surface 5 by a distance Ld. The position of the portion (that is, the intersection portion 39) where the optical axis 38b of the second light beam 37b intersects with the optical axis 38a of the first light beam 37a is away from the first surface 5 by the distance Lc. In such a case, the distance Ld, the distance Lc, and the second distance L2 can satisfy the following condition (1).

L2>Ld≥Lc (1)

That is, the first diffusion plate 35a can be disposed closer to the light sources 31a and 31b or the reflective surfaces 32a and 32b than the portion (that is, the intersection portion 39), where the first light beam 37a and the second light beam 37b intersect with each other, with respect to the first surface 5. Because the first diffusion plate 35a can be disposed in a region where the cross-sectional area (or width) of the light beam bundle 36 including the first light beam 37a and the second light beam 37b is gradually narrowed, the width (or area) of the first diffusion plate 35a can be reduced, and because the light beam bundle 36 enters the first diffusion plate 35a while being narrowed, the likelihood that a part of the light beam bundle 36 does not hit the first diffusion plate 35a and reaches the first surface 5 while maintaining the directivity can be reduced.

The light source device 10 can include an optical element that monolithically has the first reflective surface 32a and the second reflective surface 32b. As in the present example, the light source device 10 can include a first optical element (that is, the first reflecting plate) 33a and a second optical element (that is, the second reflecting plate) 33b. The first optical element 33a has the first reflective surface 32a. The second optical element 33b has the second reflective surface 32b having the angle θ2 that can be set independently of the angle θ1 of the first reflective surface 32a. By separately providing the first reflecting plate 33a having the first reflective surface 32a and the second reflecting plate 33b having the second reflective surface 32b, a reflection angle is easily adjusted. Moreover, as illustrated in FIG. 1, because the area of each of the reflecting plates 33a and 33b can be reduced and the reflecting plates 33a and 33b can be disposed individually at interval(s), when the reflecting plates 33a and 33b common to the plurality of light source devices 10 are provided, advantages such as economic efficiency, a simple support structure, and easiness to obtain a cooling effect can be expected.

The light source device 10 can include the third laser light source 31c and the third reflecting plate (that is, a third optical element) 33c. The third laser light source 31c is disposed at the third distance L3 shorter than the second distance L2 from the first surface 5 in the first direction (Z direction). The third reflecting plate 33c has the third reflective surface 32c, and is disposed at a third position P3 further away from the third laser light source 31c in the second direction (Y direction) than the second position P2. The third reflective surface 32c can reflect the third light beam 37c from the third laser light source 31c toward a third portion 6c that is away from the first portion 6a of the first surface 5 in the second direction (Y direction) and in the same direction (that is, +Y direction) as the third position P3 with respect to the first position P1. Moreover, the light source device 10 can include the second diffusion plate 35b through which the third light beam 37c passes, and the second diffusion plate 35b can be separated from the first diffusion plate 35a.

In the light source device 10, because the first light beam 37a and the second light beam 37b intersect with each other at the intersection portion 39, the area (or width) of the first diffusion plate 35a can be reduced. Accordingly, the second diffusion plate 35b through which the third light beam 37c passes is output separately from the first light beam 37a and the second light beam 37b in the Y direction do not have to be common with the first diffusion plate 35a. Separately positioning the first diffusion plate 35a and the second diffusion plate 35b can reduce the area (or width) occupied by each of the first diffusion plate 35a and the second diffusion plate 35b. Because the diffusion plates 35a and 35b can be disposed individually at an interval, the diffusion plates 35a and 35b common to the plurality of light source devices 10 can be provided as illustrated in FIG. 1 with expectations of advantages such as economic efficiency, a simple support structure, and easiness to obtain a cooling effect.

The substrate 20 having the first support surface 21 supporting the first laser light source 31a and the second laser light source 31b can be a heat dissipation substrate. The heat dissipation substrate can be a substrate having high thermal conductivity such as copper, aluminum, or aluminum nitride, can be a substrate provided with a heat sink, or can be a substrate including a forcible cooling mechanism such as water cooling or air cooling.

The light source device 10 can include the fourth laser light source 31d and the fourth reflecting plate (that is, a fourth optical element) 33d. The fourth laser light source 31d is disposed on the second support surface 22 opposite to the first support surface 21 of the heat dissipation substrate 20. The fourth reflecting plate 33d has the fourth reflective surface 32d that reflects a fourth light beam 37d from the fourth laser light source 31d toward a fourth portion 6d different from the first portion 6a and the second portion 6b of the first surface 5. The light source device 10 can include a third diffusion plate 35c through which the fourth light beam 37d passes. The third diffusion plate 35c can be a diffusion plate separated from the first diffusion plate 35a. In the light source device 10, the plurality of laser light sources 31a to 31d are disposed on the respective support surfaces 21 and 22 of the heat dissipation substrate 20 extending in the Z direction, and the light beams 37a to 37d can be output from the laser light sources 31a to 31d. Accordingly, the laser beam 7 having a higher energy density can be emitted to the first surface 5 to be irradiated. In addition, providing the third diffusion plate 35c can also reduce the directivity of the fourth light beam 37d. In addition, because the first diffusion plate 35a can be narrowed to correspond to the first light beam 37a and the second light beam 37b intersecting with each other, the third diffusion plate 35c can be separated from the first diffusion plate 35a. This can provide the light source device 10 that is economical, has high heat resistance, and has a simple support structure.

The light source device 10 can include the fifth laser light source 31e and the sixth laser light source 31f. The fifth laser light source 31e is disposed on the second support surface 22 opposite to the first support surface 21 of the heat dissipation substrate 20, and disposed at a position opposite to the first laser light source 31a. The sixth laser light source 31f is disposed on the second support surface 22 and at a position opposite to the second laser light source 31b. The fifth laser light source 31e and the sixth laser light source 31f can be disposed plane-symmetrically to the first laser light source 31a and the second laser light source 31b, and a reference plane (that is, a first reference plane) 81 of the plane symmetry can be an XZ plane including the first virtual axis 8. The light source device 10 can further include the fifth reflecting plate (that is, an optical element) 33e and the sixth reflecting plate (that is, an optical element) 33f. The fifth reflecting plate 33e has the fifth reflective surface 32e at a position and in a direction symmetrical to the first reflective surface 32a with respect to the first reference plane 81. The sixth reflecting plate 33f has a sixth reflective surface 32f at a position and in a direction symmetrical to the second reflective surface 32b with respect to the first reference plane 81. The optical element for providing the reflective surface is not limited to the reflecting plate and can be another optical element such as a prism, and the reflecting plate in the present specification can be replaced with such an optical element.

The light source device 10 can further include a fourth diffusion plate 35d common to the fifth light beam 37e and a sixth light beam 37f. The fifth light beam 37e is emitted from the fifth laser light source 31e, and reflected by the fifth reflective surface 32e. The sixth light beam 37f is emitted from the sixth laser light source 31f, and reflected by the sixth reflective surface 32f. The diffusion plate 35d can be a diffusion plate separated from the first diffusion plate 35a. A typical diffusion plate in the present specification is, for example, a transparent or transmissive plate-shaped member formed of glass. The diffusion plate in the present specification can be of a type that appears milky white for diffusion, can be of a ground glass type in which numerous irregularities are formed on the surface thereof, can be of a type in which numerous microlenses are formed on the surface thereof, and can be of any type as long as it exhibits at least a diffusion effect in the wavelength band of the laser beam output from the laser light source and can reduce directivity.

The fourth diffusion plate 35d can be disposed at a position symmetrical to the first diffusion plate 35a with respect to the first reference plane 81. The positional relationship of the sixth reflective surface 32f with respect to the fifth reflective surface 32e in the second direction (Y direction) along the first surface 5 to be irradiated is determined as the third positional relationship. The positional relationship (that is, +Y direction) of a sixth portion of the first surface 5 (toward which the sixth light beam 37f is directed) with respect to a fifth portion 6e of the first surface 5 (toward which the fifth light beam 37e is directed) is determined as the fourth positional relationship. The fourth positional relationship is the reverse of the third positional relationship, and thus the intersection portion 39 between the fifth light 37e and the sixth light 37f occurs at the position Lc on the way toward the first surface 5. Accordingly, like the light beam bundle 36 including the first light beam 37a and the second light beam 37b, a light beam bundle including the fifth light beam 37e and the sixth light beam 37f is narrowed in a cross-sectional area (or width) and then widened, and the fourth diffusion plate 35a can be disposed at a position symmetrical to the first diffusion plate 35d in the narrowed portion.

The light source device 10 can reflect the fifth light beam 37e and the sixth light beam 37f from the fifth laser light source 31e and the sixth laser light source 31f by the fifth reflective surface 32e and the sixth reflective surface 32f at different angles such that the fifth light beam 37e and the sixth light beam 37f intersect with each other at the intersection portion 39 where an optical axis 38e and an optical axis 38f are at the position (distance) Lc, the fifth laser light source 31e and the sixth laser light source 31f being disposed along the first virtual axis 8 extending in the first direction (Z direction) parallel to the second support surface 22 of the heat dissipation substrate 20.

A lower module 26 including the fifth laser light source 31e, the sixth laser light source 31f, the fifth reflective surface 32e, the sixth reflective surface 32f, and the fourth diffusion plate 35d is disposed symmetrically to an upper module 25 including the first laser light source 31a, the second laser light source 31b, the first reflective surface 32a, the second reflective surface 32b, and the first diffusion plate 35a with respect to the first reference plane 81, so that the lower module 26 can also satisfy the above condition (1). Therefore, the light source device 10 can symmetrically emit a plurality of laser beams from the upper module 25 and the lower module 26 disposed above and below the reference plane 81 toward the first surface 5 to be irradiated, thereby providing the light source device 10 that can irradiate a wide range with the laser beam 7 uniformized with a high energy density.

In the light source device 10 including the upper module 25 and the lower module 26, the second reflective surface 32b can be set so as to reflect the second light beam 37b in a direction in which the second portion 6b is positioned between a fifth portion 6e, to which the fifth light beam 37e is directed, and a sixth portion 6f, to which the sixth light beam 37f is directed, of the first surface 5 to be irradiated. The second portion 6b irradiated with the light beam 37b of a part of the upper module 25 disposed above (that is, in the +Y direction) the heat dissipation substrate 20 and the sixth portion 6f irradiated with the light beam 37f of a part of the lower module 26 disposed below (that is, in the −Y direction) the heat dissipation substrate 20 can be vertically switched. The illuminance of a portion in the elongated direction (for example, the direction of the virtual axis 8 and the center of the first surface) of the heat dissipation substrate 20 serving as the boundary between the upper module 25 and the lower module 26 can be inhibited from being too strong or too weak. Therefore, the first surface 5 can be irradiated with the laser beam 7 that is more uniform.

An example of the light source device 10 can be a device in which at least three laser light sources including the first laser light source 31a and the second laser light source 31b are disposed on the first support surface 21 of the heat dissipation substrate 20. A plurality of laser light sources including the first laser light sources 31a and the second laser light sources 31b can be disposed on the first support surface 21 of the heat dissipation substrate 20 in a third direction (X direction) orthogonal to the first direction (Z direction) along the virtual axis 8 and the second direction (Y direction) in which the reflective surfaces are disposed. That is, as illustrated in FIG. 1, the light source device 10 can be a unit including one first laser light source 31a and one second laser light source 31b, or can be a unit in which a plurality of first laser light sources 31a and a plurality of second laser light sources 31b are disposed in the X direction. The same applies to the light source device 10 in which four or more laser light sources are disposed in the Z direction, and the same applies to the light source device 10 in which one or a plurality of laser light sources are disposed on the second support surface 22 of the heat dissipation substrate 20. In addition, as described above, the reflecting plate and the diffusion plate can also extend (be long) in the X direction so that a process can be performed in common with light from a plurality of laser light sources disposed in the X direction, or can be divided in the X direction such that a process can be individually performed with light from each laser light source.

The first laser light source 31a and the second laser light source 31b can be light sources each including a single laser diode (hereinafter, referred to as an LD chip), or can be LD packages each including a plurality of LD chips. The laser diode can be a semiconductor laser element.

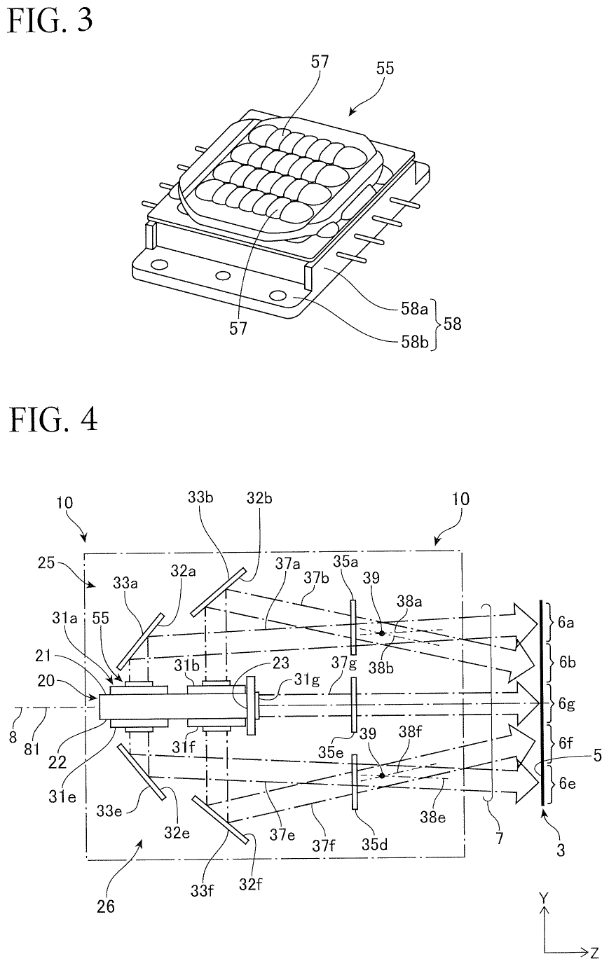

FIG. 3 illustrates an example of a laser diode (LD) package 55. The LD package 55 includes a base 58 and a collimator lens 57 illustrated in FIG. 3.

The base 58 can be formed of, for example, a metal material such as iron, an iron alloy, or copper. The base 58 can also be formed of a ceramic material such as AlN, SiC, or SiN. The base 58 can also be formed by using different materials for a base portion 58b and a lateral-wall portion 58a and then joining the base portion 58b and the lateral-wall portion 58a. A metal lead pin can be provided on the lateral-wall portion 58a to be used as a part of wiring. An insulating member can be provided between the lateral-wall portion 58a and the lead pin to prevent short-circuiting.

The collimator lens 57 includes a plurality of lens surfaces disposed in a matrix of M rows and N columns (M is an integer ≥2 and Nis an integer ≥3). The lens portion corresponds to the number of semiconductor laser elements to be mounted. The collimator lens 57 can be formed by using a light transmissive material such as glass or synthetic quartz.

The LD chips are arranged in a matrix of M rows and N columns. A laser beam emitted from each LD chip passes through one of the lens surfaces of the collimator lens 57 and is extracted to the outside. The emission peak wavelength of the LD chip can be, for example, in a range from 420 nm to 750 nm. The LD chip can emit a blue laser beam, and the emission peak wavelength thereof can be in a range from 420 nm to 490 nm. The LD chip can be a multi-mode laser to increase the output power. Each of the first laser light source 31a to the sixth laser light source 31f of the present example can be the LD package 55 in which LD chips 55a disposed in a 4× 7 matrix are packaged. Accordingly, in the light source device 10 illustrated in FIG. 2, the first surface 5 can be irradiated with the laser beam 7 in which laser beams output from 168 LD chips 55a are collected.

FIG. 4 illustrates another example of the light source device 10. In the light source device 10, the first laser light source 31a and the second laser light source 31b are mounted on the first support surface 21 of the heat dissipation substrate 20, and the fifth laser light source 31e and the sixth laser light source 31f are mounted on the second support surface 22. The light source device 10 further includes a seventh laser light source 31g disposed on a third support surface 23 of the heat dissipation substrate 20 facing the first surface 5. The seventh laser light source 31g emits a seventh light beam 37g toward the first surface 5 via no reflective surface. The light source device 10 further includes a fifth diffusion plate 35e through which the seventh light beam 37g passes. The fifth diffusion plate 35e can be separated from the first diffusion plate 35a.

In the light source device 10, the seventh laser light source 31g can be provided that emits the laser beam 37g toward the first surface 5, by using an end surface of the heat dissipation substrate 20 facing the first surface 5 as the third support surface 23. Accordingly, the intensity of the laser beam 7 emitted to the first surface 5 can be further improved. In addition, because the laser beam 37g can be output from the boundary between the upper module 25 and the lower module 26, the illuminance distribution at the boundary portion between the modules 25 and 26 can be made more uniform.

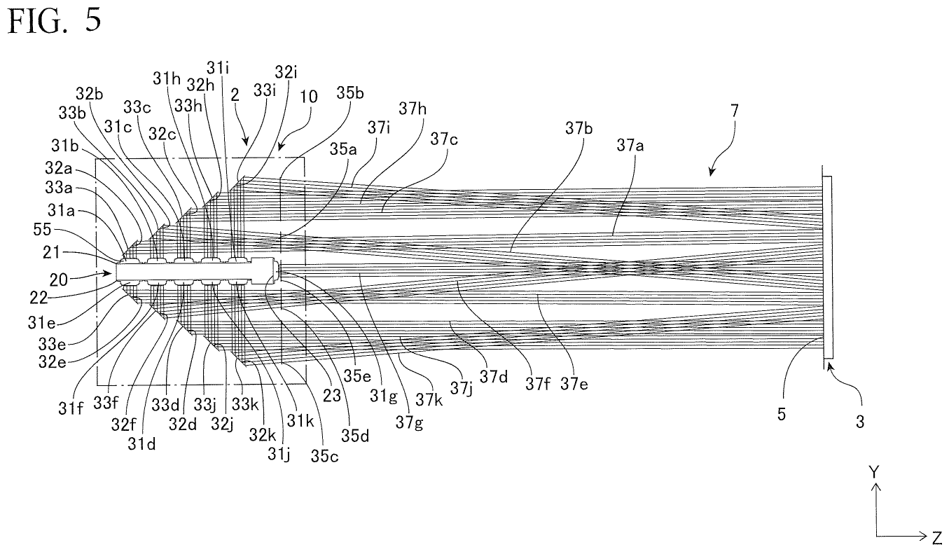

FIG. 5 illustrates another example of the light source device 10. In the light source device 10, in addition to the first laser light source 31a to the third laser light source 31c, an eighth laser light source 31h and a ninth laser light source 31i are mounted on the first support surface 21 of the heat dissipation substrate 20. In addition to the fourth laser light source 31d to the sixth laser light source 31f, a tenth laser light source 31j and an eleventh laser light source 31k are mounted on the second support surface 22. Accordingly, eleven laser light sources 31a to 31k including the seventh laser light source 31g mounted on the support surface 23, that is the end surface, are mounted on the heat dissipation substrate 20. Each of the laser light sources 31a to 31k can be the LD package 55, and the light source device 10 can emit the laser beam 7 obtained by bundling light beams from a total of 308 LD 55a toward the first surface 5. As illustrated in FIG. 5, the laser beam 7 is emitted so as to be dense on the first surface 5.

The light source device 10 includes an eighth reflecting plate 33h and a ninth reflecting plate 33i. The eighth reflecting plate 33 has an eighth reflective surface 32h for reflecting an eighth light beam 37h from the eighth laser light source 31h toward the first surface 5. The ninth reflecting plate 33i has a ninth reflective surface 32i for reflecting a ninth light beam 37i from the ninth laser light source 31i toward the first surface 5. The eighth reflective surface 32h and the ninth reflective surface 32i are set so as to reflect the eighth light beam 37h and the ninth light beam 37i, respectively, at an angle with which the eighth light beam 37h and the ninth light beam 37i each intersect with the third light beam 37c. The eighth light beam 37h and the ninth light beam 37i pass through the second diffusion plate 35b common with the third light beam 37c and are output in a diffused state toward the first surface 5 to be irradiated.

The light source device 10 further includes a tenth reflecting plate 33j and an eleventh reflecting plate 33k. The tenth reflecting plate 33j has a tenth reflective surface 32j for reflecting a tenth light beam 37j from the tenth laser light source 31j toward the first surface 5. The eleventh reflecting plate 33k has an eleventh reflective surface 32k for reflecting an eleventh light beam 37k from the eleventh laser light source 31k toward the first surface 5. The tenth reflective surface 32j and the eleventh reflective surface 32k are set so as to reflect the tenth light beam 37j and the eleventh light beam 37k, respectively, at an angle with which the tenth light beam 37j and the eleventh light beam 37k each intersect with the fourth light beam 37d. The tenth light beam 37j and the eleventh light beam 37k pass through the third diffusion plate 35c common with the fourth light beam 37d and are output in a diffused state toward the first surface 5 to be irradiated.

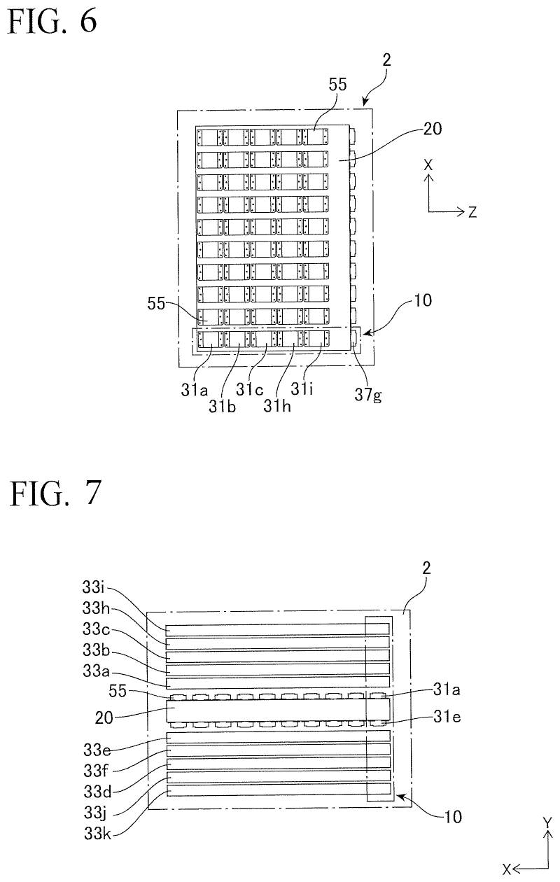

As illustrated in FIGS. 6 and 7, the heating device 2 can include ten light source devices 10 arranged in the X direction being the conveyance direction. The heat dissipation substrate 20 can be a substrate common to the plurality of light source devices 10. Each of the reflecting plates 33a to 33f and 33h to 33k can be a reflecting plate common to the plurality of light source devices 10.

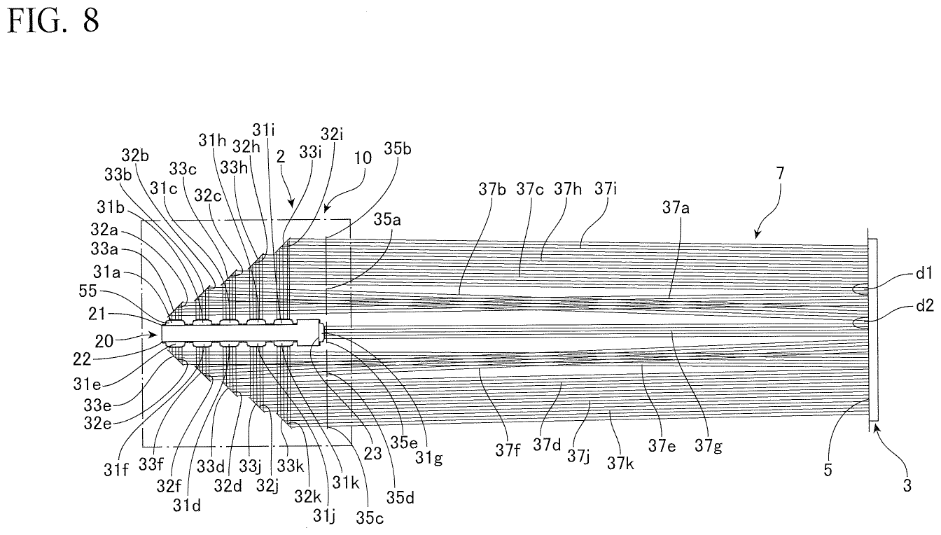

FIG. 8 illustrates another example of the light source device 10. The light source device 10 also includes eleven laser light sources 31a to 31k mounted on the first support surface 21 to the third support surface 23 of the heat dissipation substrate 20, and ten reflective surfaces 32a to 32f and 32h to 32k. The eighth reflective surface 32h and the ninth reflective surface 32i are set so as to reflect the eighth light beam 37h and the ninth light beam 37i, respectively, at an angle with which the eighth light beam 37h and the ninth light beam 37i do not intersect with the third light beam 37c, preferably at an angle with which the eighth light beam 37h and the ninth light beam 37i are parallel to the third light beam 37c. The eighth light beam 37h and the ninth light beam 37i pass through the second diffusion plate 35b common with the third light beam 37c and are output in a diffused state toward the first surface 5 to be irradiated. The tenth reflective surface 32j and the eleventh reflective surface 32k are set so as to reflect the tenth light beam 37j and the eleventh light beam 37k, respectively, at an angle with which the tenth light beam 37j and the eleventh light beam 37k do not intersect with the fourth light beam 37d, preferably at an angle with which the tenth light beam 37j and the eleventh light beam 37k are parallel to the fourth light beam 37d. The tenth light beam 37j and the eleventh light beam 37k pass through the third diffusion plate 35c common with the fourth light beam 37d and are output in a diffused state toward the first surface 5 to be irradiated.

The angles of these reflective surfaces 32a to 32f and 32h to 32k can be designed such that almost no interval d1 between light beam bundles of the light beams 37a to 37f and 37h to 37k reflected by these reflective surfaces is generated when the light beam bundles reach the first surface 5. On the other hand, in a case in which the light beam bundles reflected by these reflective surfaces overlap each other on the first surface, this causes a variation in illuminance. Therefore, the light beam bundles do not have overlap each other. In addition, an interval d2 between the light beam bundle of the seventh light beam 37g traveling toward the first surface 5 via no reflective surface and the light beam bundle of the second light beam 37b or the sixth light beam 37f traveling toward the first surface 5 via the reflective surface can be equal to or larger than the interval d1 between the light beam bundles of the light beams 37a to 37f and 37h to 37k reflected by the reflective surfaces 32a to 32f and 32h to 32k, when the light beam bundles reach the first surface 5.

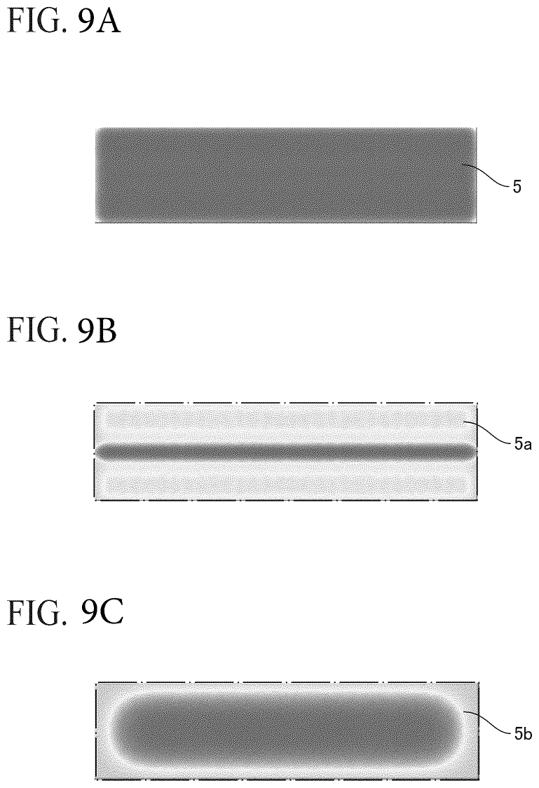

FIG. 9A shows an example of an illuminance distribution on the first surface 5 to be irradiated. FIG. 9A is an example of a simulation result of an illuminance distribution when irradiation is performed by the heating device 2 including a plurality of the light source devices 10 in FIG. 8. The divergence angle of the diffusion plate was 3.1° at full width at half maximum. From the simulation, the uniformity ratio was 86%.

FIG. 9B is an image showing a simulation result 5a of a comparative example. The arrangement and the number of laser light sources are the same as those in FIG. 8, but the laser light sources are different from those of the light source device in FIG. 8 in the following points. That is, they are different from those of the light source device 10 of FIG. 8 in that all the reflective surfaces are disposed such that the incident angles of laser beams are 45° and the laser beams are emitted parallel to each other. The set divergence angle of the diffusion plate is 3.1° at full width at half maximum, and is the same as the setting of the simulation shown in FIG. 9A. It is assumed that one diffusion plate identical to that of the light source device 10 in FIG. 8 is used. That is, it is assumed that a diffusion plate having a size enough to diffuse all the laser beams is used. The result shown in FIG. 9B was a clearly non-uniform distribution compared with the result shown in FIG. 9A.

FIG. 9C is an image showing a simulation result 5b of another comparative example.

FIG. 9C is obtained by performing simulation under the same settings as those in the comparative example of FIG. 9B except that the divergence angle of the diffusion plate was set to 15° at full width at half maximum and was larger than that of the diffusion plate of the light source device in FIG. 8. In the result shown in FIG. 9C, the illuminance distribution was improved by increasing the divergence angle of the diffusion plate compared with the result shown in FIG. 9B. The uniformity ratio of the illuminance distribution was 66%.

The above results show that the light source device of the embodiment has the highest uniformity ratio and is advantageous in obtaining a more uniform illuminance distribution.

Note that the number of laser light sources that can be mounted on the heat dissipation substrate 20 is not limited to 11 and can be 10 or less or 12 or more. In the light source device 10 of the present example, by expanding the area of the heat dissipation substrate 20 and disposing optical elements for forming reflective surfaces respectively corresponding to laser light sources mounted, light beams from a large number of laser light sources can be bundled to generate the laser beam 7 with high energy density and high uniformity and the laser beam 7 can be output to the first surface 5 to be irradiated.

What is claimed is:

1. A light source device comprising:
a first laser light source configured to emit first light, and disposed at a first distance, in a first direction, from a first surface to be irradiated;
a second laser light source configured to emit second light, and disposed at a second distance from the first surface in the first direction, the second distance being shorter than the first distance;
a first reflective surface disposed at a first position away from the first laser light source in a second direction along the first surface, the first reflective surface being configured to reflect the first light toward a first portion of the first surface;
a second reflective surface disposed at a second position further away from the second laser light source in the second direction than the first position is away from the first laser light source in the second direction, the second reflective surface being configured to reflect the second light toward a second portion of the first surface; and
a first diffusion plate on which the first light and the second light are incident, wherein
the second portion of the first surface is positioned away from the first portion of the first surface in the second direction, and
the first portion of the first surface and the second portion of the first surface are reversed compared to the first position and the second position in the second direction.

2. The light source device according to claim 1, wherein
a reflection angle of the second reflective surface is set such that an optical axis of the second light intersects with an optical axis of the first light after reflection, and
in the first direction,
the first diffusion plate is away from the first surface by a distance Ld,
a position where the optical axis of the second light intersects with the optical axis of the first light is away from the first surface by a distance Lc, and
the distance Ld, the distance Lc, and the second distance L2 satisfy L2>Ld≥Lc.

3. The light source device according to claim 1, further comprising:
a first optical element comprising the first reflective surface having a first angle; and
a second optical element that comprises the second reflective surface having a second angle that is settable independently of the first angle of the first reflective surface.

4. The light source device according to claim 1, further comprising:
a third laser light source configured to emit third light, the third laser light source being disposed at a third distance from the first surface in the first direction, the third distance being shorter than the second distance;
a third reflective surface configured to reflect the third light toward a third portion that is away from the first portion of the first surface in a same direction as the third position with respect to the first position in the second direction; and
a second diffusion plate through which the third light passes, the second diffusion plate being separated from the first diffusion plate, wherein
the third reflective surface is disposed at a third position further away from the third laser light source in the second direction than the second position is away from the second laser light source in the second direction.

5. The light source device according to claim 1, further comprising:
a heat dissipation substrate having a first support surface supporting the first laser light source and the second laser light source.

6. The light source device according to claim 5, further comprising:
a fourth laser light source configured to emit fourth light, the fourth laser light source being disposed on a second support surface opposite to the first support surface of the heat dissipation substrate;
a fourth reflective surface configured to reflect the fourth light toward a fourth portion of the first surface different from the first portion and the second portion of the first surface; and
a third diffusion plate through which the fourth light passes, the third diffusion plate being separated from the first diffusion plate.

7. The light source device according to claim 5, further comprising:
a fifth laser light source disposed on a second support surface opposite to the first support surface of the heat dissipation substrate while being disposed at a portion opposite to a portion where the first laser light source is disposed;
a sixth laser light source disposed on the second support surface while being disposed at a portion opposite to a portion where the second laser light source is disposed;
a fifth reflective surface disposed at a position and in a direction such that the fifth reflective surface is symmetrical to the first reflective surface with respect to a first reference plane about which an arrangement of the fifth laser light source and the sixth laser light source is plane-symmetrical to an arrangement of the first laser light source and the second laser light source;
a sixth reflective surface disposed at a position and in a direction such that the sixth reflective surface is symmetrical to the second reflective surface with respect to the first reference plane; and
a fourth diffusion plate being common to fifth light that is emitted from the fifth laser light source and is reflected by the fifth reflective surface, and to sixth light that is emitted from the sixth laser light source and is reflected by the sixth reflective surface, the fourth diffusion plate being separated from the first diffusion plate.

8. The light source device according to claim 7, wherein the fourth diffusion plate is disposed at a position symmetrical to the first diffusion plate with respect to the first reference plane.

9. The light source device according to claim 8, wherein the second reflective surface is configured to reflect the second light toward the second portion positioned between a fifth portion to which the fifth light is directed and a sixth portion to which the sixth light is directed.

10. The light source device according to claim 5, further comprising:
a seventh laser light source configured to emit seventh light toward the first surface, the seventh laser light source being disposed on a third support surface of the heat dissipation substrate, the third support surface facing the first surface; and
a fifth diffusion plate through which the seventh light passes, the fifth diffusion plate being separated from the first diffusion plate.

11. The light source device according to claim 5, wherein at least three laser light sources comprising the first laser light source and the second laser light source are disposed on the first support surface of the heat dissipation substrate.

12. The light source device according to claim 1, wherein a plurality of the first laser light sources and a plurality of the second laser light sources are disposed in a third direction orthogonal to both the first direction and the second direction.

13. The light source device according to claim 1, wherein each of the first laser light source and the second laser light source comprises a plurality of laser elements.

14. A light source device comprising:
a heat dissipation substrate having a first support surface;
a first laser light source and a second laser light source disposed along a first virtual axis extending in a first direction parallel to the first support surface;
a first reflective surface configured to reflect first light from the first laser light source at a first position in the first direction such that the first light forms a first angle with respect to the first virtual axis, the first position being away from the first virtual axis in a second direction orthogonal to the first support surface;
a second reflective surface configured to reflect second light from the second laser light source at a second position in the first direction such that the second light forms a second angle larger than the first angle with respect to the first virtual axis, the second position being further away from the first virtual axis in the second direction than the first position is away from the first virtual axis in the second direction, the second reflective surface being configured to cause an optical axis of the first light and an optical axis of the second light to intersect with each other; and
a first diffusion plate common to the first light and the second light.

15. A heating system comprising:
a conveyance device configured to convey a heating target in a predetermined direction; and
a heating device configured to emit a heating laser beam toward the conveyance device, wherein
the heating device comprises a plurality of the light source devices according to claim 1.

16. A heating system comprising:
a conveyance device configured to convey a heating target in a predetermined direction; and
a heating device configured to emit a heating laser beam toward the conveyance device, wherein
the heating device comprises a plurality of the light source devices according to claim 14.
